(19) United States
(12) Patent Application Publication
(10) Pub. No.: US 2006/0224461 A1
(43) Pub. Date: Oct. 5, 2006

(54) Systems and methods for providing client based photo user interface

(75) Inventors: Louis J. Montulli, Reno, NV (US); James H. Clark, Redwood City, CA (US); Jeffrey N. Whitehead, San Jose, CA (US); Jason F. Harrison, San Jose, CA (US); Aleksander K. Totic, San Francisco, CA (US); Garrett A. Blythe, Cupertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,264

(22) Filed: Feb. 24, 2005

(51) Int. Cl. G06Q 30/00

(52) U.S. Cl. 705/26

(57) ABSTRACT

Systems and methods are disclosed for providing a user interface for a set of multimedia assets distributed between a web service and a local client by uploading the set of distributed multimedia assets to the web service from the local client and subsequently updating the set of distributed multimedia assets; automatically synchronizing the set of distributed multimedia assets; and displaying the synchronized set of distributed multimedia assets on the user interface.

The invention relates generally to digital image processing systems.

People take photographs so their memories can be shared with others. Conventionally, photographers sort through negatives, make trips to the photo store, separate copies for friends and family and make yet another trip to the post office. Recent advances in on-line photofinishing technology have enabled digital photographers to instantly share photos with friends and family worldwide. Existing solutions use a server to provide a web service that stores and prints photos. Exemplary on-line photo service providers include Shutterfly, Ofoto, and Snapfish, among others. For example, Shutterfly provides client software as well as a web-based system to upload photos. Once pictures have been uploaded to a Shutterfly account, the user can enhance the pictures as needed by reducing red eye and cropping images. The user can also personalize them with a message on the back and get creative by enhancing the color, changing color pictures to black and white, or adding a choice of borders on front. It is also easy to send prints to friends and family or to share pictures online. As another example, Snapfish enables users to upload photos and allows the initiation of a web based print window. The user views the Snapfish site, selects “upload” and chooses photos on his or her computer to upload. Alternatively, the user can email photos to Snapfish from a camera phone or his or her email account. For conventional film users, the film rolls are sent to Snapfish, and the company automatically scans and uploads photos online-so the user can enjoy the benefits of digital photos without a digital camera.

The storing of on-line photos on the photo service providers as well as on the user's local computer causes synchronization problems, particularly when edits have been done on the photos. As discussed in Application Serial No. 20040133924, in cases where the user “saves” any or all of the changes, all edit operations that have been performed and saved are applied to each pixel in the image such that the original image at the pixel level is overwritten. In this case, the original image, also referred to as a “digital negative”, is forever lost. If the user wishes, however, to save the digital image, the user must save the changes to another file thereby preserving the original digital negative. The 20040133924 application provides for automatically synchronizing any of a group of associated multimedia assets. A particular one of the set of distributed multimedia assets is modified and the others of the set of distributed multimedia assets are then synchronized based upon the modification. An update edit list corresponding to the modification is generated which is then automatically forwarded to the others of the set of distributed multimedia assets. The update edit list is then used to synchronize each of the distributed multimedia assets to the particular multimedia asset so modified.

### SUMMARY

Systems and methods are disclosed for providing a user interface for a set of multimedia assets distributed between a web service and a local client by uploading the set of distributed multimedia assets to the web service from the local client and subsequently updating the set of distributed multimedia assets; automatically synchronizing the set of distributed multimedia assets; and displaying the synchronized set of distributed multimedia assets on the user interface.

Implementations of the above system can include one or more of the following. The system can include a web based photo service with a local client interface. The client is a program that runs on the user's local computer. The web service can be a server that stores and prints photos such as services from Shutterfly, Ofoto, and Snapfish, among others. The client program acts as a complete user interface to the web based photo service providing full bidirectional syncing of content and viewing of local and remotely stored images. Meta-data is also bi-directionally synchronized and searchable. The on-line print ordering process is encapsulated into a local client program user interface and not an HTML user interface. The client-based interface to the photo printing service offers a rich user interface and minimizes network and caching limitations that make the user experience less than optimal. By combining the web service and local client software that interfaces with the web service, the system provides a rich user experience with faster access to photos and multimedia and a more expressive user interface. The system can provide for the automatic archival of data to a web service using the local client program. The client program can automatically back up photos and other multimedia assets to the web service without the need for the user to initiate an explicit upload command or instruction.

These and other advantages of the present invention will become apparent upon reading the following detailed descriptions and studying the various figures of the drawings.

### BRIEF DESCRIPTION OF THE DRAWINGS

Embodiments of the invention, together with further advantages thereof, may best be understood by reference to the following description taken in conjunction with the accompanying drawings in which:

FIG. 1 illustrates a system for transferring information between one or more client computers or other suitable client systems and a server.

FIG. 2 illustrates an exemplary process for synchronizing data between the client and the server.

FIG. 3 shows an exemplary process for providing a user interface for a set of multimedia assets distributed between a web service and a local client.

### DESCRIPTION

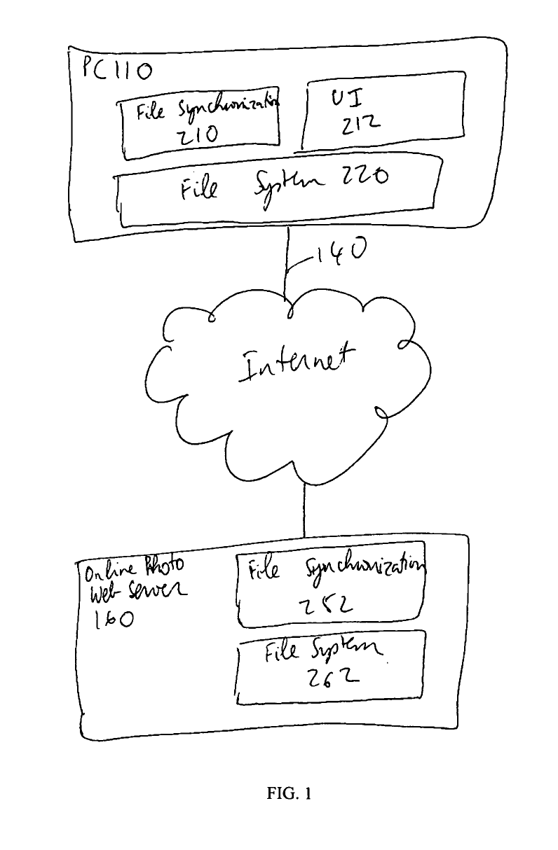

FIG. 1 illustrates a system for transferring information between one or more client computers 110 or other suitable client systems and a server 160. The method of FIG. 1 consists of a multimedia (including image) synchronization system or file transfer system. In the client 110, a first file transfer program 210 runs on the client 110 to manage file transfers from the client. The file transfer program 210 communicates with a local file system 220 that is responsible for creating and storing multimedia files such as image files. The file transfer program 210 communicates across a communication link 140 (such as a broadband link including DSL or a wireless link over 802.11, Bluetooth, or GPRS protocols, among others) to a server 160 through a server file transfer program 252 that runs on the server 160. The file transfer program 252 communicates with a local file system 262 on the server 160.

The file transfer program 210 provides automatic archival of data to the web service running on the server 160. The file transfer program 210 automatically backs up photos and other multimedia assets to the web service without the need for the user to initiate an explicit upload step. Meta-data can also be bi-directionally synchronized and searchable.

The client 110 also provides a user interface 212. The user interface 212 allows the user to view images even if the user is not logged into the server 160. Additionally, the user interface 212 allows the user to order prints, and the print ordering is encapsulated into the program's local user interface instead of an HTML-based user interface.

In one embodiment, to minimize data transmission requirement a user may indicate that images may be shared one at a time or, alternatively, a plurality of images can be marked for sharing/synchronization of images and associated image data. Only selected images are then synchronized with the server 160.

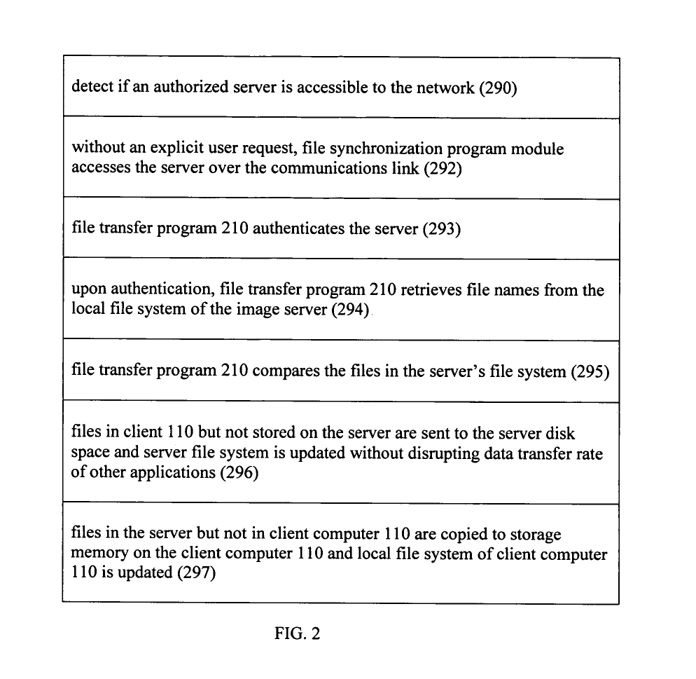

To invoke the file transfer system of FIG. 1, FIG. 2 shows an exemplary automatic image file synchronization process without user instruction. The process detects if an authorized server is accessible to the network (290). If so, without an explicit user request, the file synchronization program module accesses the server over the communications link (292). The file transfer program 210 authenticates the server (293), and upon authentication, file transfer program 210 retrieves file names from the local file system of the image server (294). Next, the file transfer program 210 compares the files in the server's file system (295). Files in phone 110 but not stored on the server are sent to the server disk space and server file system is updated without disrupting data transfer rate of other applications (296). Correspondingly, files in the server but not in client computer 110 are copied to storage memory on the client computer 110 and local file system of client computer 110 is updated (297).

In one embodiment, the syncing of multimedia data is achieved without disrupting existing broadband data transfer speed. This is done by syncing the data back to the network server over the wide area network only when surplus data bandwidth is available and only excess bandwidth is consumed to synchronize image data between the client computer 110 and the server 160. The system synchronizes image data only when excess network bandwidth is available. In one embodiment, the system determines the network's maximum upload bandwidth, determines current data transmission utilization of the network; and synchronizes image data only when the current data transmission utilization of the network is below the maximum upload bandwidth of the network.

In one embodiment, to speed up the synchronization of images between the two cell phones, the file transfer system 210 operates only on individual files in the two computer systems such that no individual record analysis is done. For example, the file transfer programs on each computer can compare the dates of files on each system and transfer the more recent version from one system over to the other. In other embodiments, client computers with matching applications can share information on a record level. For example, an address book containing names, pictures, phone numbers, and addresses of people in records can be merged at a record level.

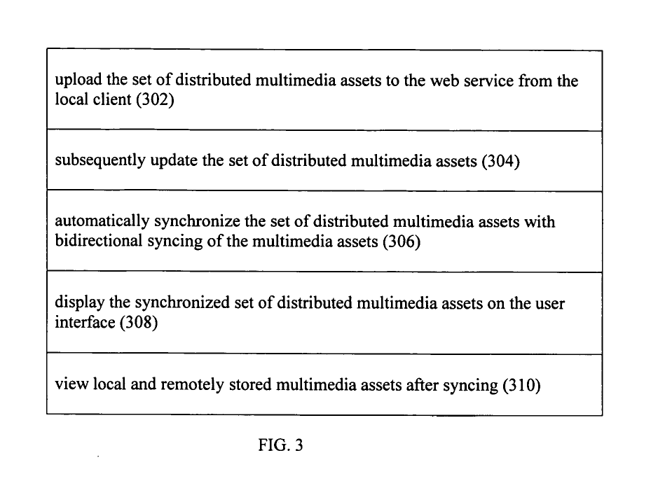

FIG. 3 shows an exemplary process to provide a user interface for a set of multimedia assets distributed between a web service and a local client. The process starts when a user uploads the set of distributed multimedia assets to the web service from the local client (302). Subsequently, the user updates the set of distributed multimedia assets (304). The updating can include adding new pictures into the set of multimedia assets. Alternatively, the updating of the set can occur when the user edits or visually manipulates one asset in the set. The process automatically synchronizes the set of distributed multimedia assets with bidirectional syncing of the multimedia assets (306). The process then displays the synchronized set of distributed multimedia assets on the user interface (308). The user can view local and remotely stored multimedia assets after syncing (310).

The client program acts as a complete user interface to the web based photo service providing full bidirectional syncing of content and viewing of local and remotely stored images. Meta-data is also bi-directionally synchronized and searchable. The on-line print ordering process is encapsulated into a local client program user interface and not an HTML user interface. The client-based interface to the photo printing service offers a rich user interface and minimizes network and caching limitations that make the user experience less than optimal. By combining the web service and local client software that interfaces with the web service, the system provides a rich user experience with faster access to photos and multimedia and a more expressive user interface. The system can provide for the automatic archival of data to a web service using the local client program. The client program can automatically back up photos and other multimedia assets to the web service without the need for the user to initiate an explicit upload command or instruction.

In this disclosure and claims, the terms “transfer” and “transmit” or their derivatives are may be equivalent when transference is done through transmission. Images include image data and image data includes images. Also, in this disclosure and claims, the term “automatically” is meant to mean that something is done without the need for further input from a user.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. For example, although the buffer memory is described as high speed static random access memory (SRAM), the memory can be any suitable memory, including DRAM, EEPROMs, flash, and ferro-electric elements, for example. The invention may be implemented in digital electronic circuitry or in computer hardware, firmware, software, or in combinations of them.

Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

While the above embodiments have involved application of luminescent substances to dental structures, the invention is applicable to all non-opaque surfaces.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for providing a user interface for a set of multimedia assets distributed between a web service and a local client, comprising:
uploading the set of distributed multimedia assets to the web service from the local client and subsequently updating the set of distributed multimedia assets;
automatically synchronizing the set of distributed multimedia assets; and
displaying the synchronized set of distributed multimedia assets on the user interface.

2. The method of claim 1, wherein the synchronizing of the set of multimedia assets comprises bidirectional syncing of the multimedia assets and wherein the displaying comprises viewing local and remotely stored multimedia assets after syncing.

3. The method of claim 1, wherein at least one of the multimedia assets comprises meta-data to search the asset.

4. The method of claim 3, comprising synchronizing the meta-data.

5. The method of claim 3, comprising searching for one or more assets based on the meta-data.

6. The method of claim 1, comprising archiving the multimedia assets on the web service.

7. The method of claim 1, comprising transferring the multimedia assets to the web service without an explicit upload command issued by a user.

8. The method of claim 1, wherein the multimedia assets comprise one of:
images, photos, sounds, video.

9. The method of claim 1, comprising providing on-line print ordering.

10. The method of claim 9, wherein the on-line print ordering user interface is encapsulated into the client instead of a web interface.

11. A system to provide a user interface for a set of multimedia assets distributed between a web service and a local client, comprising:
means for uploading the set of distributed multimedia assets to the web service from the local client and subsequently updating the set of distributed multimedia assets;
means for automatically synchronizing the set of distributed multimedia assets; and
means for displaying the synchronized set of distributed multimedia assets on the user interface.

12. The system of claim 11, wherein the means for synchronizing of the set of multimedia assets comprises means for bidirectional syncing of the multimedia assets and wherein the means for displaying comprises means for viewing local and remotely stored multimedia assets after syncing.

13. The system of claim 11, wherein at least one of the multimedia assets comprises meta-data to search the asset.

14. The system of claim 13, comprising means for synchronizing the meta-data.

15. The system of claim 13, comprising means for searching for one or more assets based on the meta-data.

16. The system of claim 11, comprising means for archiving the multimedia assets on the web service.

17. The system of claim 11, comprising means for transferring the multimedia assets to the web service without an explicit upload command issued by a user.

18. The system of claim 11, wherein the multimedia assets comprise one of:
images, photos, sounds, video.

19. The system of claim 11, comprising means for providing on-line print ordering.

20. The system of claim 19, wherein the on-line print ordering user interface is encapsulated into the client instead of a web interface.
